(19) United States
(12) Patent Application Publication
(10) Pub. No.: US 2003/0084041 A1
(43) Pub. Date: May 1, 2003

(54) Programmer's dynamic spellchecker

(75) Inventor: Richard Dean Dettinger, Rochester, MN (US)

Correspondence Address: Gero G. McClellan, Moser, Patterson & Sheridan, L.L.P., Suite 1500, 3040 Post Oak Boulevard, Houston, TX, 77056-6582, US

(73) Assignee: International Business Machines Corporation, Armonk, NY

(21) Appl. No.: 09/982,323

(22) Filed: Oct. 18, 2001

(51) Int. Cl. G06F 17/30

(52) U.S. Cl. 707/5

(57) ABSTRACT

Methods, apparatus and articles of manufacture for determining the validity of words within a programming environment. In one embodiment, an operation of context-sensitive word validity checking in a programming environment is provided. The method comprises, in response to receiving user input information at an input location in the programming environment, determining a context of the input location; determining a validity of the user input information relative to the context; and outputting a visual indication of any invalid user input information.

### BACKGROUND OF THE INVENTION

1. Field of the Invention

The present invention generally relates to data processing. More particularly, the invention relates to word validity checking capabilities in a programming environment.

2. Description of the Related Art

Spell checking programs are commonly incorporated into desktop publishing programs (e.g., word processors) which involve typing words to form a part of a document, spread sheet, or database, etc. Current spell checking programs typically check each word in the document against a spelling dictionary database. If the word does not exist in a spelling dictionary database (i.e., a misspelled word), the spell checking program provides a list of correctly spelled words that may be selected to replace the misspelled word. A user of the spell checking program selects the correct word which replaces the misspelled word and then proceeds to correct the next misspelled word.

In a programming environment the need for effective spell checking is critical to the successful execution of code. Misspellings in a programming environment can lead to hours of debugging. A common approach to identifying misspellings is to compile the program. Further, because locating misspellings becomes increasingly difficult with increasing volume of code, programmers typically compile frequently. However, this approach is undesirable because, while potentially decreasing the time spent debugging, the time spent periodically compiling is a significant source of overhead.

Further, programming presents special problems with regard to spell checking because programmers are not limited to a predefined pool of code terms. Rather, programmers are free to define terms to suit their needs. In addition, spelling in programs is highly sensitive to context. For example, whether a term is correctly spelled is contingent on whether the programmer is typing inside or outside a particular method or whether the programmer is typing a comment. As a result, the use of a “static” dictionary containing predefined terms that are universally applied (as is used for word processors) is not a viable solution. Further, the ability to manually add custom terms is of little value because the large volume of new programming terms for any give program and the limitations imposed by scoping issues renders such functionality ineffective.

Therefore, there is a need for a spell checker configured for programming environments.

### SUMMARY OF THE INVENTION

The present invention generally provides methods, apparatus, and articles of manufacture for determining the validity of words within a programming environment. In one embodiment, a method of context-sensitive word validity checking in a programming environment is provided. The method comprises receiving user input information at an input location in the programming environment; determining a context of the input location; determining a plurality of relevant terms selected according to the context; and determining a validity of the user input information against the plurality of relevant terms.

Another embodiment provides a computer comprising a processor and a memory containing a development tool, a word validity checker and at least one variable dictionary and at least one static dictionary, wherein the at least one variable dictionary is configured to contain user-defined terms specific to the programming environment and the at least one static dictionary contains terms persistent between programming environments. The processor, when configured with the development tool, processes user input in a programming environment and, when configured with the word validity checker, is configured to perform an operation for determining the validity of user input. The operation comprises, in response to receiving user input information at an input location in the programming environment, determining a plurality of relevant terms selected according to the input location wherein at least a portion of the relevant terms are selected from the at least one static dictionary and a portion of the relevant terms are stored to the at least one variable dictionary; and determining a validity of the user input information against the plurality of relevant terms.

Another embodiment provides a method for performing an operation of context-sensitive word validity checking in a programming environment. The method comprises, in response to receiving user input information at an input location in the programming environment, determining a context of the input location; determining a validity of the user input information relative to the context; and outputting a visual indication of any invalid user input information.

In yet another embodiment, the foregoing methods, operations and functions are implemented by a program contained on a computer readable medium.

### BRIEF DESCRIPTION OF THE DRAWINGS

So that the manner in which the above recited features, advantages and objects of the present invention are attained and can be understood in detail, a more particular description of the invention, briefly summarized above, may be had by reference to the embodiments thereof which are illustrated in the appended drawings.

It is to be noted, however, that the appended drawings illustrate only typical embodiments of this invention and are therefore not to be considered limiting of its scope, for the invention may admit to other equally effective embodiments.

FIG. 1 is a high level diagram of a computer system configured with a programming environment spell checker.

FIG. 2 is a flow chart illustrating the operation of the programming environment word validity checker.

FIG. 3 is a flow chart illustrating a method for determining active dictionaries.

FIG. 4 is a flow chart illustrating a method for determining valid tokens.

FIG. 5 is a flow chart illustrating a method for determining whether a user defined word is valid for a particular scope.

FIG. 6 is sample code illustrating validity check features.

### DETAILED DESCRIPTION OF THE PREFERRED EMBODIMENTS

The present invention provides methods, apparatus, and articles of manufacture for determining the validity of words within a programming environment. Although referred to herein as “spell checking”, more generally aspects of the invention may be understood as work validity checks, which include spelling and syntax validations.

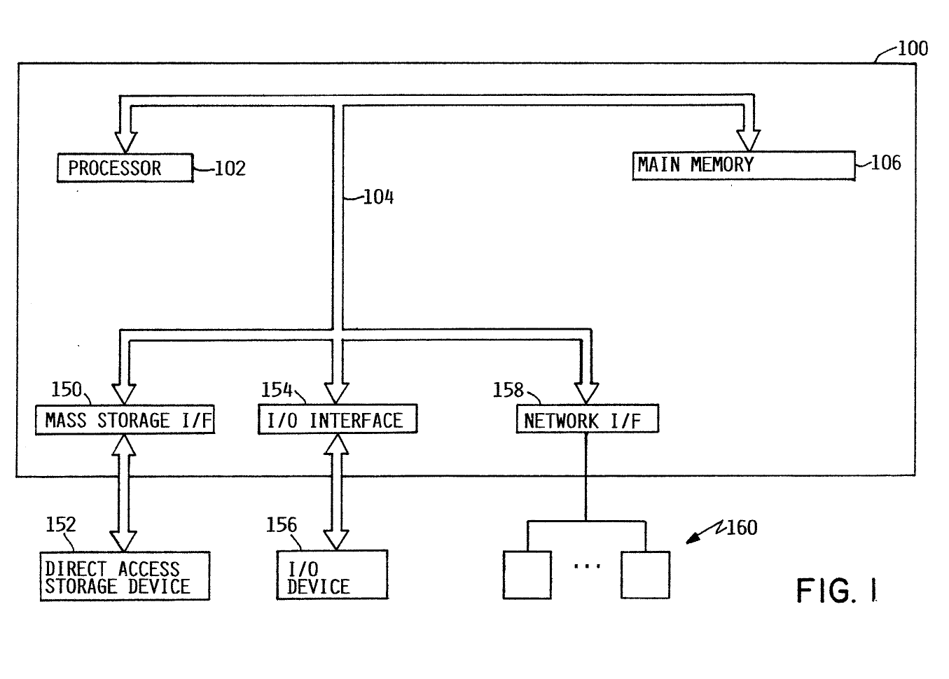

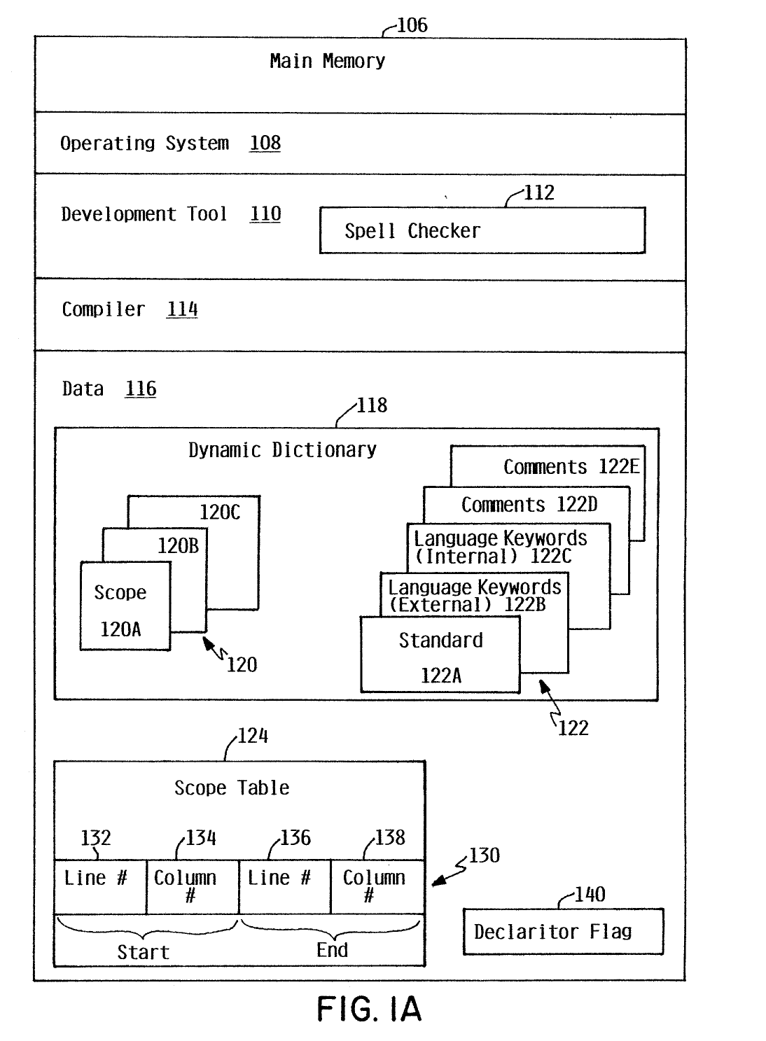

One embodiment of the invention is implemented as a program product for use with a computer system such as, for example, the computer system 100 shown in FIG. 1 and described below. The program(s) of the program product defines functions of the embodiments (including the methods described below) and can be contained on a variety of signal-bearing media. Illustrative signal-bearing media include, but are not limited to: (i) information permanently stored on non-writable storage media (e.g., read-only memory devices within a computer such as CD-ROM disks readable by a CD-ROM drive); (ii) alterable information stored on writable storage media (e.g., floppy disks within a diskette drive or hard-disk drive); or (iii) information conveyed to a computer by a communications medium, such as through a computer or telephone network, including wireless communications. The latter embodiment specifically includes information downloaded from the Internet and other networks. Such signal-bearing media, when carrying computer-readable instructions that direct the functions of the present invention, represent embodiments of the present invention.

In general, the routines executed to implement the embodiments of the invention, whether implemented as part of an operating system or a specific application, component, program, module, object, or sequence of instructions may be referred to herein as a “program”. The computer program typically is comprised of a multitude of instructions that will be translated by the native computer into a machine-readable format and hence executable instructions. Also, programs are comprised of variables and data structures that either reside locally to the program or are found in memory or on storage devices. In addition, various programs described hereinafter may be identified based upon the application for which they are implemented in a specific embodiment of the invention. However, it should be appreciated that any particular program nomenclature that follows is used merely for convenience, and thus the invention should not be limited to use solely in any specific application identified and/or implied by such nomenclature.

Moreover, those skilled in the art will appreciate that embodiments may be practiced with any computer system configurations including hand-held devices, multiprocessor systems, microprocessor-based or programmable consumer electronics, minicomputers, mainframe computers and the like. The embodiments may also be practiced in distributed computing environments where tasks are performed by remote processing devices that are linked through a communications network. In a distributed computing environment, program modules may be located in both local and remote memory storage devices.

Computer system 100 is shown for a multi-user programming environment that includes at least one processor 102, which obtains instructions and data via a bus 104 from a main memory 106. Illustratively, the processor is a PowerPC available from International Business Machines of Armonk, N.Y. More generally, however, any processor configured to implement the methods of the present invention may be used to advantage.

The computer system 100 includes a number of operators and peripheral systems. Illustratively, these include a mass storage interface 150 operably connected to a direct access storage device 152, a input/output (I/O) interface 154 operably connected to I/O devices 156, and a network interface 158 operably connected to a plurality of networked devices 160. The I/O devices may include any combination of displays, keyboards, track point devices, mouse devices, speech recognition devices and the like. In some embodiments, the I/O devices are integrated, such as in the case of a touch screen. The networked devices 160 could be displays, desktop or PC-based computers, workstations, or network terminals, or other networked computer systems.

The main memory 106 could be one or a combination of memory devices, including Random Access Memory, nonvolatile or backup memory (e.g., programmable or Flash memories, read-only memories, MRAM, etc.) and the like. In addition, memory 106 may be considered to include memory physically located elsewhere in a computer system 100, for example, any storage capacity used as virtual memory or stored on a mass storage device or on another computer coupled to the computer system 100 via bus 104.

Illustratively, the main memory 106 includes an operating system 108, a development tool 110, a spell check program 112 (also referred to herein as the “spell checker” or “word validity checker”), a compiler 114 and data 116. The development tool 110 may be any software product adapted for entering and editing code. The spell check program 112 is generally configured to identify misspellings and apply rules of syntax to identify syntax errors. Illustratively, the spell check program 112 is a component of the development tool 110. However, in other embodiments, the spell check program 112 may be a component of another software construct (e.g., the operating system 108) or may be altogether separate from other software constructs.

In general, the data 116 includes a dynamic dictionary 118, a scope table 124 and a declaritor flag 140. The dynamic dictionary 118 includes one or more variable dictionaries 120 and a plurality of static dictionaries 122. The variable dictionaries 120 will typically include at least one scope dictionary 120A. More typically, a plurality of scope dictionaries 120A-C will be defined. Each scope dictionary 120A-C (hereinafter referred to as the scope dictionary/dictionaries 120) includes validated terms located in a particular scope of a programming environment's code. Because scope dictionaries 120 are generated and populated in response to user input, these dictionaries are referred to as “variable”. In contrast, the static dictionaries 122 are predefined, meaning they do not change in response to user input (with the exception of when a user directly modifies the contents of the dictionary, such as when the user adds a custom word). Illustrative static dictionaries 122 include a standard dictionary 122A, language keyword dictionaries 122B-C, and comment dictionaries 122D-E. The standard dictionary 122A may be a spoken language dictionary for a particular language, such as the English language. The language keyword dictionaries 122B-C are language specific (e.g., Java, C++, etc.) and are defined according to different scoping rules. For example, a first language keyword dictionary 122B contains Java keywords that are valid outside the scope of a method body, such as the words public, static, final transient, etc. A second language keyword dictionary 122C contains Java keywords that are valid inside the scope of a method body, such words include int, float, double, if, while, etc. The comment dictionaries 122D-E are also language specific and contain keywords which are valid within comments. One example of such comments are Javadoc comments keywords such as @param and @throws.

The scope table 124 provides an index of scope start positions and scope and positions to facilitate determination of relevant scopes according to a cursor position. As such, the scope table 124 is generally formatted as a plurality of columns and rows, where each row defines a record for a particular scope. For brevity, only a single row 130 is shown. A first pair of entries of the row 130 include a line number 132 and a column number 134 for the start location of a scope. A second pair of entries include a line number 136 and a column number 138 for the end location of the scope. The ability to identify scope is well-known within the art. Accordingly, a more detailed discussion is not necessary.

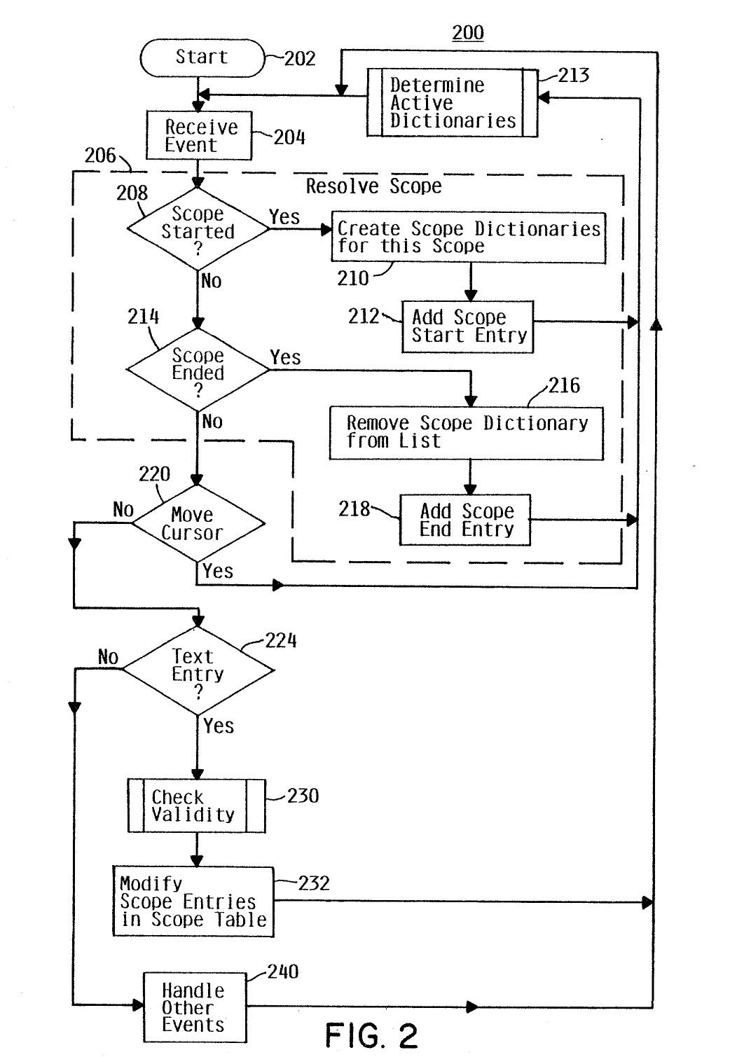

FIG. 2 is a flowchart of a method 200 illustrating the operation of the development tool 110, and more specifically the spell checker 112. For simplicity, the method 200 assumes a user is currently editing and active document. In the event that a new document is created and opened, it is contemplated that a selection of default dictionaries may be loaded. For example, an empty scope dictionary 120 may be created and the external language keywords dictionary 122B may be loaded. When a saved document containing previously entered code is opened, the last saved state of the document is reinstated.

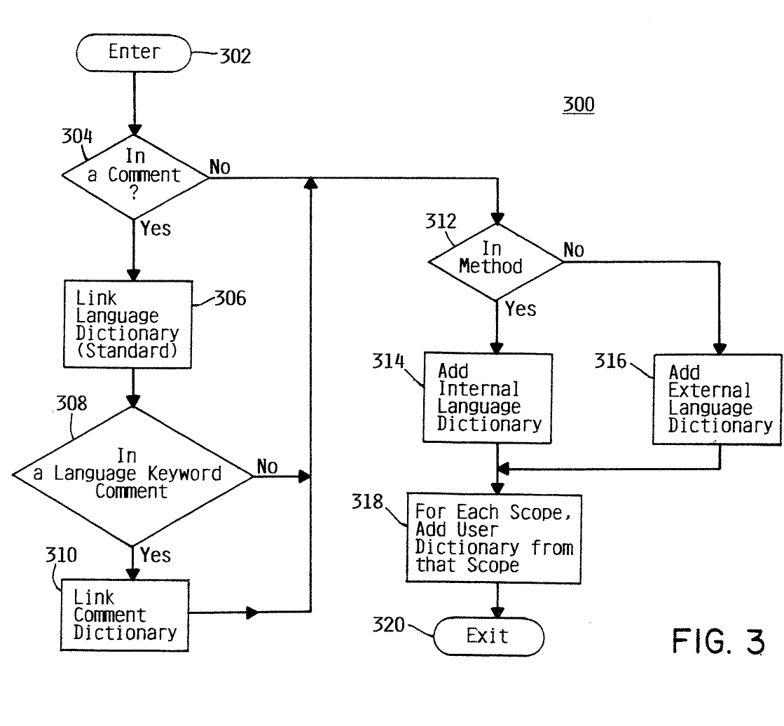

The method 200 is an event driven method which begins at step 202 and proceeds to step 204 where a user event is received. In general, user events include typing and moving a cursor (such as by moving a mouse pointer or using a keypad). At step 206, scope issues are resolved. In one embodiment, step 206 includes first determining (at step 208) whether a new scope has started as a result of the user typing the appropriate character(s). If step 208 is answered affirmatively, a scope dictionary 120 is created for the newly started scope at step 210. The scope dictionary 120 may be populated with subsequent user input and becomes available (as part of one or more active dictionaries) to determine the validity of terms. At step 212, a scope entry (i.e., line number and column number) is added to scope table 124. At step 213, the method 200 determines the active dictionaries (i.e., the dictionaries to be consulted for purposes of spell checking) which make up the dynamic dictionary 118. One embodiment of the processing handled at step 213 is described below with reference to FIG. 3. The method 200 then returns to step 204 to receive the next user event.

If step 208 is answered negatively, the method 200 proceeds to step 214 to query whether the user event results in ending a scope. If so, the scope dictionary 120 for the particular scope ended is inactivated (i.e., made unavailable for purposes of spell checking). The inactivated scope dictionary 120 is not deleted because the user may return to the particular scope at a later time.

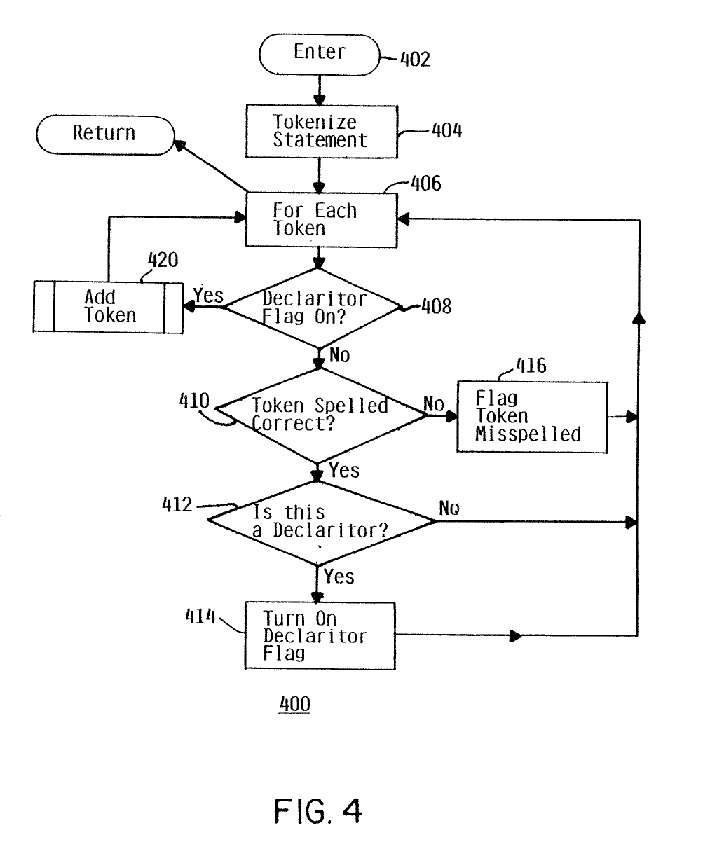

Processing then proceeds to step 220 where the method 200 queries whether the user event is a repositioning of the cursor (not due to typing). If step 220 is answered affirmatively, the method 200 proceeds to step 213 to determine the active dictionaries. Otherwise, if step 220 is answered negatively, the method 200 proceeds to step 224 and queries whether the user event is text entry (e.g., typing) at some input location in the programming environment for an existing scope (i.e., at least a scope start position exists for the cursor's current location). If so, processing proceeds to step 230 where the validity of the entered text is checked. One embodiment of the processing performed at step 230 is described below with reference to FIG. 4. The method 200 then proceeds to step 232 to modify the scope entries in the scope table 124. Specifically, the line and column numbers for some or all records of the table 124 are incremented or decremented depending on whether text is added or removed, respectively. Whether a particular record requires modification further depends on the input location, i.e., the location of the cursor. If the cursor location is before a scope start position, then both the scope start position and end position entries of the scope table 124 must be modified. If the cursor location is after a scope end position, then that particular scope entry requires no modification. If the cursor location is between a scope start position and scope end position, then only the entries for the scope end position need modification.

Returning to step 224, if the query is answered negatively, the user event is handled at step 240. The processing handled at step 224 may include manually adding a custom word to the dynamic dictionary 118 or otherwise configuring the spell checker 112. The method 200 then returns to step 204 to begin processing the next user event.

Referring now to FIG. 3, there is shown one embodiment of a method 300 illustrating step 213 of the method 200. The method 300 is entered at step 302 and proceeds to step 304 to query whether the cursor position is in a comment. If not, the method 300 proceeds to step 312. If the cursor position is in a comment, the standard language dictionary 122A is made active/linked (i.e., made available for spell checking) for the current cursor position at step 306. At step 308, the method 300 queries whether the cursor position is in a language keyword comment (e.g., a Javadoc comment). If not, the method 300 proceeds to step 312. Otherwise, the appropriate language keyword dictionary is made active at step 310. The method 300 then proceeds to step 312.

At step 312, the method 300 queries whether the cursor position is in a method body. If not, processing proceeds to step 316 where the external language keyword dictionary 122B is made active. Otherwise, if the cursor position is in a method body, processing proceeds to step 314 where the internal language keyword dictionary 122C is made active. In any case, processing then proceeds to step 318 where each relevant scope dictionary 120 is made active. The relevant scope dictionaries 120 are the dictionaries for each scope that the current cursor position is within. Accordingly, the more deeply a current cursor position is nested within levels of scope, the greater the number of relevant scope dictionaries 120 (one for each level of nesting). The method 300 exits at step 320 at which point processing returns to step 204 of FIG. 2.

Referring now to FIG. 4, there is shown one embodiment of a method 400 illustrating step 230 of the method 200. The method 400 is performed for a particular statement at which the cursor is currently located. The method 400 is entered at step 402 and proceeds to step 404 where the statement being processed is tokenized (that is, parsed and broken into logical components which may be processed, as known in the art). At step 406, the method 400 enters a loop for each token. In general, the tokens are handled moving from left to right through the statement. However, precedence is given where appropriate according to syntax which dictates order of execution. Consider for example the following statement which is a code line (i.e. not contained in a comment):

Example Statement: int value=(mint) floatValue.

In this case, contents contained in the parentheses are given precedence. Subsequently, values may be processed by the loop entered at step 406 from left to right.

At step 408, the method 400 queries whether the declaritor flag 140 is on for the token being processed. If not, the method queries at step 410 whether the token is spelled correctly. This determination is made with reference to the active dictionaries contained in the dynamic dictionary 118. Consider again the Example Statement provided above. Initially, the token int contained in the parentheses is checked for correct spelling. In this case, the token is validated because it is a language keyword and is valid within code lines (as such the token is found in the internal dictionary 122B. If the token is validated, processing proceeds to step 412 to determine whether the token is a declaritor. This may be accomplished according to processing known in the compiler art, for example. A common format for a declaritor is <type><name>=<value> and is recognizable by conventional compilers. If step 412 is answered negatively, processing returns to step 406 to begin processing the next token. If the token is a declaritor, processing proceeds to step 414 where the declaritor flag 140 is turned on. Processing then returns to step 406. Returning to step 410, if the token is spelled incorrectly the token is flag as misspelled at step 416. Misspelled words may be visually indicated to the user in a variety of ways. For example, the misspelled words may be highlighted, underlined or otherwise visually modified.

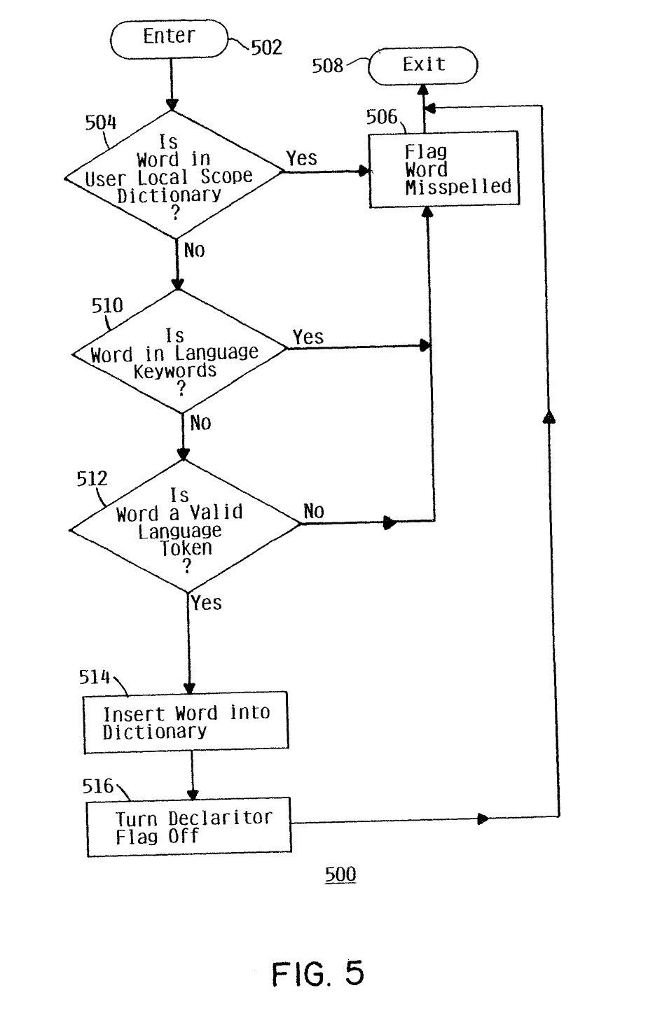

If, at step 408, the declaritor flag is on, processing proceeds to step 420 where an attempt is made to add the token being processed to the scope dictionary 120 for the current innermost scope according to the cursor position. One embodiment for attempting to add the token to a scope dictionary is described below with reference to FIG. 5. After the processing at step 420 is completed, the method 400 returns to step 406 to begin processing the next token.

FIG. 5 shows one embodiment of a method 500 for adding words (specifically declaritors) to a scope dictionary 120, as implemented by step 420 described above. More specifically, the method 500 adds words from the user's innermost scope (relative to the cursor's current position) to a scope dictionary 120 specific to that scope. Various rules are applied in implementing the method 500. For example, one illustrative rule is that the word/token being processed may not already be defined by the user for the current scope. This rule may be demonstrated by the following examples.

### EXAMPLE CODE 1:

{

int value = 10;
{

int value = 10;

}

}

### EXAMPLE CODE 2:

{

int value = 10;
int value = 10;

}

Referring first to the Example Code 1, a first scope is defined between lines 001 and 006, and a second scope is defined between lines 003 and 005. Assume that the cursor position is between lines 003 and 005. In this case, the second scope is the innermost scope. Although identical statements are located at lines 002 and 004, each statement is in a different scope and, therefore, are both valid. In contrast, the identical statements in the Example Code 2 are in the same scope, and are therefore invalid.

Accordingly, after entering at step 502, step 504 is configured to determine whether the word/token being processed is already defined for the current scope. This determination is made with reference to the scope dictionary 120 for the innermost scope of the cursor's position. If the token is already defined for the current scope, the token is flagged as misspelled at step 506 and the method 500 exits at step 508 (and then returns to step 406 of the method 400).

If step 504 is answered negatively, processing proceeds to step 510 to determine whether the token is in either of the language keyword dictionaries 122B-C. If step 510 is answered affirmatively, the token is flagged as misspelled at step 506. Otherwise, processing proceeds to step 512 and queries whether the token is a valid language token. For example, Java variables cannot start with a number. As such, any Java variables starting with a number is considered an invalid language token at step 512. If step 512 is answered negatively, the token is flagged as misspelled at step 506. However, if the token is validated at step 512, the token is inserted into the innermost scope dictionary 120. The method 500 then exits at step 508.

At step 514, the token being processed is added to the innermost scope dictionary 120. The declaritor flag 140 is then turned off at step 516, and the method 500 exits at step 508.

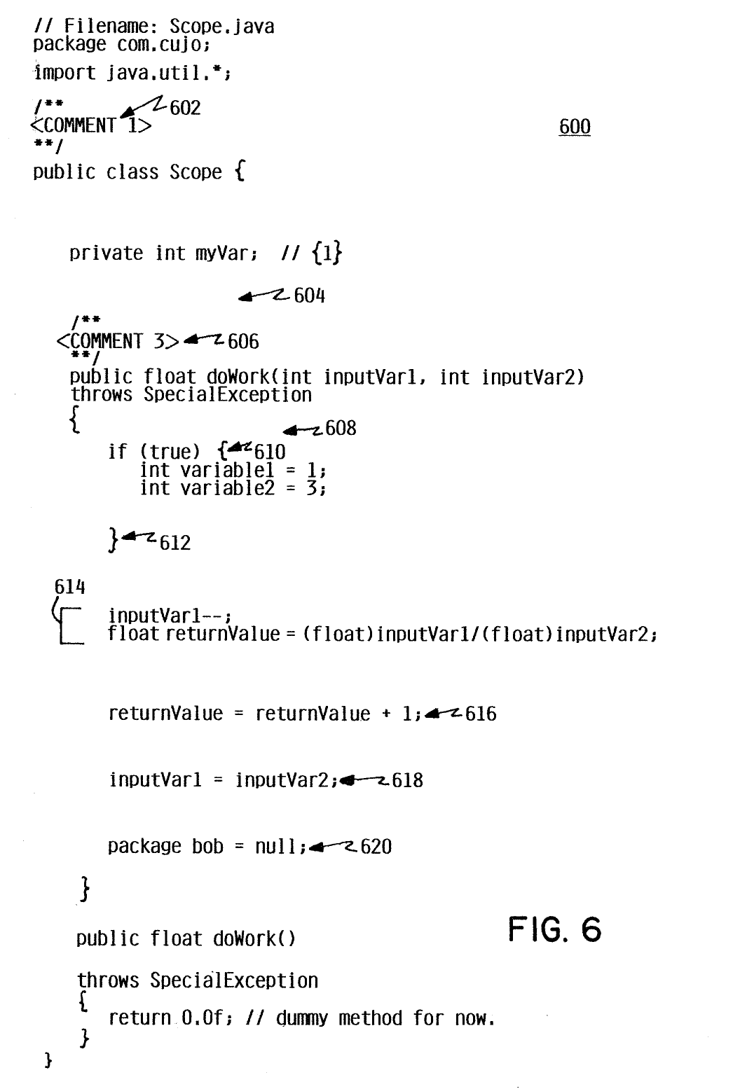

Referring out to FIG. 6, illustrative code 600 is shown which may be displayed on one of the I/O devices. The code 600 will be used to describe the inventive features disclosed herein. For purposes of illustration, the code 600 is Java; however, the inventive features may be used to advantage with any programming language. Assuming first that the user is typing within a first comment 602 which pertains to the entire class, the cursor is located in the outermost scope of the code 600. As such, the dynamic dictionary 118 includes the standard dictionary 122A, a Javadoc dictionary (i.e. one of the comments dictionary 122D-E), and a scope dictionary 120A. The scope dictionary 120A contains class variables (such as ‘myVar’, below), method names (such as ‘doWork’, below) and other public and package protected variables and methods from the package com.cujo.

Assume now that the cursor location is moved to code region 604. In this case, the spellchecker 112 recognizes the following as valid: all external language keywords and all first instances of a declared word (e.g., myVar which was declared in the statement “private int myVar”).

Assume now that the cursor location is moved to a second comment 606. At this location, the spellchecker 112 recognizes as valid all the valid words of code region 604, as well as the standard dictionary 122A and the Javadoc dictionary.

Assume now that the cursor location is moved into a method body 608. The spellchecker 118 now recognizes the following as valid: all internal language keywords (for example, int is valid, but transient is not), the input variables (inputVar1 and inputVar2), all instant variables of the class that have been declared before the current cursor position (for example, myVar declared above is a valid word here), all other methods of the class (for example doWork2 from below is valid here), all public and protected methods defined in other parts of the package are in scope and valid, other public values as derived from the import listed above (in this case, all values from java.util*).

Note that a brace 610 within the method body 608 defines another scope. While the cursor position is in this scope, the values variable1 and variable2 are valid. However, once the cursor position is moved to a location after the brace 612 ending the scope started at 610, the values variable1 and variable2 are no longer valid.

The code segment 614 will be used as an example to illustrate the language parsing rules followed by the spellchecker 112. In the case of inputVar1——, it is recognized that “——” is the decrement operator being used on the token inputVar1 and that the entire statement is ended with a semicolon. Once broken into these tokens, the spellchecker 112 determines that the statement is spelled correctly. In the case of the second statement, (float) inputVar1/(float) inputVar2; is recognized as a cast operation on two tokens named inputVar1 and inputVar2. Again, the spellchecker 112 determines that the statement is valid. Further, the word “float” is recognized as a declaritor and, therefore, returnvalue is added to the scope dictionary 120 for this scope. As a result, the statement 616 is also found to be valid.

Statement 618 provides an example of the spellchecker's 112 case sensitivity. In this example, inputvar2 is found to be invalid because the letter “v” in var2 is not capitalized.

At statement 620, the word “package” is invalid. Although “package” is a keyword of the Java language, it is not valid within the scope of a method body. Stated differently, the internal dictionary 122C is currently active by virtue of the cursor position in the method body but the word “package” is not found in the internal dictionary 122B (it is found in the external dictionary 122C). As a result, the spell checker 112 determines that the word “package” is invalid.

While the foregoing is directed to embodiments of the present invention, other and further embodiments of the invention may be devised without departing from the basic scope thereof, and the scope thereof is determined by the claims that follow.

What is claimed is:

1. A method of context-sensitive word validity checking in a programming environment, comprising:
receiving user input information at an input location in the programming environment;
determining a context of the input location;
determining a plurality of relevant terms selected according to the context; and
determining a validity of the user input information against the plurality of relevant terms.

2. The method of claim 1, wherein the plurality of relevant terms are determined according to at least one of valid syntax and spelling at the input location.

3. The method of claim 1, wherein determining the plurality of relevant terms comprises:
determining whether the input location is in a program method; and
if so, selecting a predefined dictionary containing executable method code which is syntactically correct for program methods.

4. The method of claim 1, wherein determining the plurality of relevant terms comprises:
determining whether the input location is in a comment; and
if so, selecting a predefined spoken language dictionary comprising non-executable terms.

5. The method of claim 4, wherein determining the plurality of relevant terms further comprises:
determining whether the input location is in a program method;
if so, selecting a first predefined dictionary containing executable method code which is syntactically correct for program methods; and
if the location is neither in a comment nor a program method, selecting a second predefined dictionary containing executable non-method code which is syntactically correct for locations outside program methods.

6. The method of claim 1, further comprising visually indicating invalid usages of the user input information.

7. The method of claim 1, wherein determining the plurality of relevant terms comprises:
identifying the relevant terms according to the context; and
dynamically populating a list with the relevant terms.

8. The method of claim 1, wherein determining the context comprises determining a cursor location.

9. The method of claim 8, wherein determining the context further comprises determining a scope for the cursor location.

10. The method of claim 9, wherein the plurality of relevant terms change in response to moving the cursor location to another scope.

11. The method of claim 10, wherein the plurality of relevant terms remain unchanged with a change in the cursor location within the scope.

12. A computer, comprising:
a memory containing a development tool, a word validity checker and at least one variable dictionary and at least one static dictionary, wherein the at least one variable dictionary is configured to contain user-defined terms specific to the programming environment and the at least one static dictionary contains terms persistent between programming environments;
a processor which when configured with the development tool processes user input in a programming environment and when configured with the word validity checker is configured to perform an operation comprising:
in response to receiving user input information at an input location in the programming environment, determining a plurality of relevant terms selected according to the input location wherein at least a portion of the relevant terms are selected from the at least one static dictionary and a portion of the relevant terms are stored to the at least one variable dictionary; and
determining a validity of the user input information against the plurality of relevant terms.

13. The computer of claim 12, further comprising an output device and wherein the processor is configured to cause a visual indication of invalid usages of the user input information on the output device.

14. The computer of claim 12, wherein the processor is configured to determine the plurality of relevant terms according to at least one of valid syntax and spelling at the input location

15. The computer of claim 12, wherein determining the plurality of relevant terms comprises:
determining whether the input location is in a program method; and
if so, selecting one dictionary from the at least one static dictionary containing executable method code which is syntactically correct for program methods.

16. The computer of claim 12, wherein determining the plurality of relevant terms comprises:
determining whether the input location is in a comment; and
if so, selecting a spoken language dictionary from the at least one static dictionary comprising non-executable terms.

17. The computer of claim 16, wherein determining the plurality of relevant terms further comprises:
determining whether the input location is in a program method;
if so, selecting a first dictionary from the at least one static dictionary containing method executable code which is syntactically correct for program methods; and
if the location is neither in a comment nor a program method, selecting a second dictionary from the at least one static dictionary containing non-method executable code which is syntactically correct for locations outside program methods.

18. The computer of claim 12, wherein determining the plurality of relevant terms comprises determining a scope for the input location.

19. The computer of claim 18, wherein the processor is configured to identify another scope in response to moving a cursor location to the another scope.

20. A computer readable medium containing a word validity check program which when executed, performs an operation of context-sensitive word validity checking in a programming environment, the operation comprising:
in response to receiving user input information at an input location in the programming environment, determining a context of the input location;
determining a plurality of relevant terms selected according to the context; and
determining a validity of the user input information against the plurality of relevant terms.

21. The computer readable medium of claim 20, wherein the operation further comprises outputting a visual indication of any invalid user input information.

22. The computer readable medium of claim 20, wherein the plurality of relevant terms are determined according to at least one of valid syntax and spelling relative to the input location.

23. The computer readable medium of claim 20, wherein determining the plurality of relevant terms comprises:
determining whether the input location is in a program method; and
if so, selecting a predefined dictionary containing executable method code which is syntactically correct for program methods.

24. The computer readable medium of claim 20, wherein determining the plurality of relevant terms comprises:
determining whether the input location is in a comment; and
if so, selecting a predefined spoken language dictionary comprising non-executable terms.

25. The computer readable medium of claim 24, wherein determining the plurality of relevant terms further comprises:
determining whether the input location is in a program method;
if so, selecting a first predefined dictionary containing executable method code which is syntactically correct for program methods; and
if the location is neither in a comment nor a program method, selecting a second predefined dictionary containing executable non-method code which is syntactically correct for locations outside program methods.

26. The computer readable medium of claim 20, wherein determining the context comprises determining a cursor location.

27. The computer readable medium of claim 20, wherein determining the context comprises:
determining a cursor location; and
determining a scope for the cursor location.

28. The computer readable medium of claim 27, wherein the plurality of relevant terms change in response to moving the cursor location to another scope.

29. The computer readable medium of claim 27, wherein the plurality of relevant terms remain unchanged with a change in the cursor location within the scope.

30. A computer readable medium containing a word validity check program which when executed, performs an operation of context-sensitive word validity checking in a programming environment, the operation comprising:
in response to receiving user input information at an input location in the programming environment, determining a context of the input location;
determining a validity of the user input information relative to the context; and
outputting a visual indication of any invalid user input information.

31. The computer readable medium of claim 30, wherein determining the validity comprises determining at least one of valid syntax and spelling relative to the input location.

32. The computer readable medium of claim 30, wherein determining the context comprises determining whether the input location is in a program method and, if so, wherein the validity comprises determining whether the user input information is syntactically correct method code.

33. The computer readable medium of claim 30, wherein determining the context comprises determining whether the input location is in a comment and, if so, wherein determining the validity comprises determining whether the user input information is spelled correctly according to a spoken language dictionary and a program language keyword dictionary.

34. The computer readable medium of claim 30, wherein determining the context comprises determining a scope according to a cursor location.
